(19) United States
(12) Patent Application Publication
(10) Pub. No.: US 2009/0092435 A1
(43) Pub. Date: Apr. 9, 2009

(54) Liquid soap or lotion applicator

(76) Inventor: James H. Stevens, Pittsburgh, PA (US)

Correspondence Address: Floyd B. Carothers;CAROTHERS AND CAROTHERS, Suite 200, 445 Fort Pitt Blvd., Pittsburgh, PA, 15219, US

(21) Appl. No.: 12/082,866

(22) Filed: Apr. 16, 2008

Related U.S. Application Data
(60) Provisional application No. 60/960,592, filed on Oct. 5, 2007.

(51) Int. Cl. A46B 5/02; A46B 11/00; B43M 11/06

(52) U.S. Cl. 401/6; 401/138; 401/140; 401/185; 401/268

(57) ABSTRACT

A liquid soap or lotion applicator for hard to reach areas of the body which includes in combination a substantially rigid elongated tubular handle with a low pressure squeeze bulb secured to one end of the tubular handle for forcing air under low pressure through the tube handle, and a hollow head connected to the opposite end of the tubular handle. The head is provided with a reservoir that communicates with the hollow interior of the tubular handle and is further provided with a removable access for pouring liquid soap or lotion into the reservoir. A porous applicator is removably secured to head with the interior surface of the applicator exposed to the reservoir whereby liquid in the reservoir will be forced through the porous applicator for application to the body when the bulb is squeezed. The tubular handle has a fixed arcuate shape which extends through a curvature of 90° to 180°, and the exterior face of the porous applicator faces anywhere in the range from in line with the tube end to a direction facing the squeeze bulb.

### CROSS REFERENCE

This application claims the benefit of U.S. Provisional Application No. 60/960,592, filed on Oct. 5, 2007, and entitled BODY BUTLER.

### BACKGROUND OF THE INVENTION

The present invention relates to devices for applying soap or suntan lotion, and more particularly to devices for applying soap or suntan lotion to a user's back and other hard to reach areas of the body.

It is virtually impossible for one to apply suntan lotion to one's back without assistance. This is true for one of normal physical capabilities, and the problem becomes more exacerbated when one has physical limitations, such as torn rotor cups in the shoulders.

The same holds true for being able to scrub one's back when taking a shower. In addition, people with other physical disabilities, such as extreme arthritis or extreme obesity have a great difficulty in washing hard to reach areas of the body, such as the area of the genitals and anus. To date, there are a number of applicators disclosed in the prior art for lotions, they are inadequate for users who have the aforesaid physical limitations.

### SUMMARY OF THE INVENTION

The liquid soap or lotion applicator for hard to reach areas of the body of the present invention includes in combination, a substantially rigid elongated tubular handle with a low pressure squeeze bulb secured to one end of the tubular handle for forcing air under low pressure through the elongated tubular handle, and a hollow head is connected to the opposite end of the elongated tubular handle. The head is provided with a reservoir which communicates with the hollow tubular interior of the handle and is capable of containing either soap or lotion which is poured into the reservoir through a removable access in the head. A porous applicator is removably secured to the head with the interior face of the applicator exposed to the reservoir whereby liquid in the reservoir will be forced through the porous applicator for application to the body. A principal feature of the applicator of the present invention is that the handle has a fixed arcuate shape which extends through a large curvature of 90° to 180°. It is this feature which permits one of limited physical capabilities, due to arthritis, extreme obesity, torn rotator cups in the shoulders, etc. to be able to apply lotion to one's back or to wash hard to reach areas with the applicator and a liquid soap, such as private areas between one's legs.

The porous applicator is removable and may be substituted with different types of applicators. For example, one applicator porous applicator may have a terrycloth cover for applying suntan lotion, and a different attachment porous head may have bristles thereon for soap application to one's body.

The applicator of the present invention is made to be even more efficiently usable by one having the aforesaid physical limitations by reason of the fact that the exterior face of the porous applicator faces in a range from inline with the end of the tube to a direction facing the squeeze bulb. This orientation of the porous applicator in combination with the severe arc of the handle renders the apparatus to be much more capable of reaching hard to reach areas of the body by one having extreme physical limitations.

In addition, the tubular handle may be reattachably divisible intermediate its opposite ends whereby the handle may be separated in half for convenient storage.

### BRIEF DESCRIPTION OF THE DRAWINGS

Other objects and advantages appear hereinafter in the following description and claims. The appended drawings, show for the purpose of exemplification without limiting the scope of the invention or appended claims, certain practical embodiments of the invention wherein:

FIG. 1 is a view in side elevation of one embodiment of the liquid soap or lotion applicator of the present invention;

FIG. 2 is a view in side elevation illustrating another embodiment of the applicator of the present invention;

FIG. 3 is a segmented view showing the head portion of the applicator of FIG. 2 with an alternate porous applicator attached which has bristles for scrubbing body parts;

FIG. 4 is a perspective view of the applicator shown in FIG. 2 without a terrycloth cover over the porous applicator and without segmentation of the handle portion; and

FIG. 5 is a bottom view of the embodiment shown in FIG. 4.

### DETAILED DESCRIPTION OF THE PREFERRED EMBODIMENTS

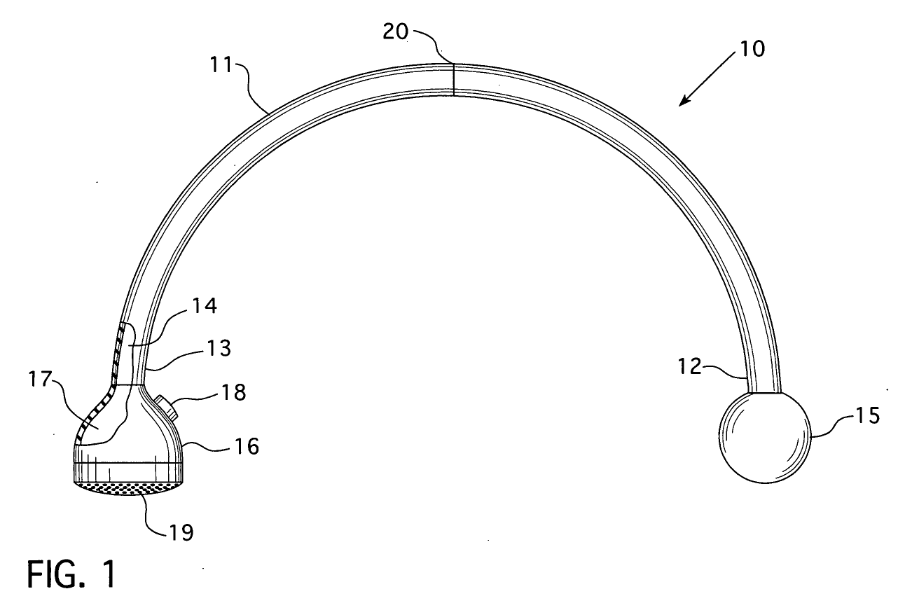

Referring to FIG. 1, the liquid or lotion applicator 10 of the present invention includes in combination a substantially rigid elongated tubular handle 11 having opposite ends 12 and 13 and a hollow interior 14. A low pressure squeeze bulb 15 is secured to one end 12 of the tubular handle 11 for forcing air under low pressure through the elongated tubular handle 11. Head 16 is connected to the opposite end 13 of elongated tubular handle 11 and is provided with a reservoir 17 therein which communicates with the hollow tubular interior 14 of handle 11. Head 16 is provided with a removable access 18 for pouring liquid soap or lotion therein.

A porous applicator 19 is removably securable, such as by threads, to head 16. Porous applicator 19 has an interior face (not shown) which is exposed to the reservoir 17 whereby liquid in the reservoir 17 will be forced through the porous applicator 19 for application to the body.

The substantially rigid tubular handle 11 is provided with a fixed arcuate shape as illustrated which extends through a curvature of 90° to 180°. In FIG. 1, the handle extends through a curvature of almost 180°. This contour is a configuration which provides the applicator of the present invention with the true ability to reach hard to reach areas for application of lotion or scrubbing even for those with severe physical limitations.

In this embodiment, the tubular handle 11 is divisible or separable as indicated at 20 by a keyed snap connection for convenient storage.

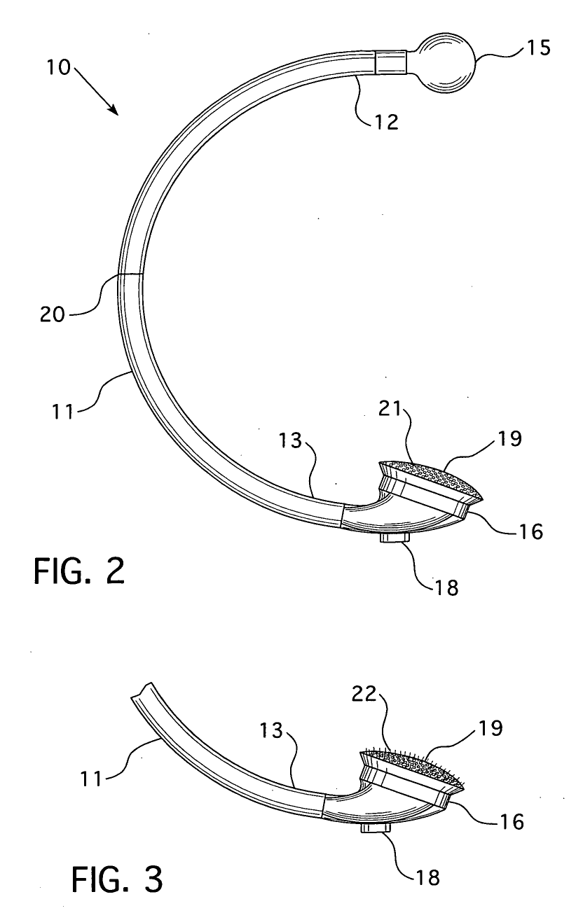

Referring next to the embodiment illustrated in FIG. 2, the porous applicator 19 is oriented differently from the embodiment shown in FIG. 1. In FIG. 1, the porous applicator 19 is basically in line with tube end 13, whereas in FIG. 2, porous applicator 19 almost faces squeeze bulb 15. By positioning porous applicator 19 in a range from inline with opposite tube end 13 to a position facing squeeze bulb 15, this provides an applicator which is much more usable and versatile for one having extreme physical limitations, particularly when made in combination with the extreme arcuate shape of tubular handle 11.

In FIG. 2, porous applicator 19 is covered with a removable terrycloth cover 21, which is appropriate for either scrubbing one's body with soap or applying lotion to one's body, such as suntan lotion. Cover 21 may be removed and washed.

As an alternative, FIG. 3 illustrates a removable porous applicator 19 which is provided with external bristles 22, which is particularly useful for soap scrubbing applications of hard to reach areas of the body.

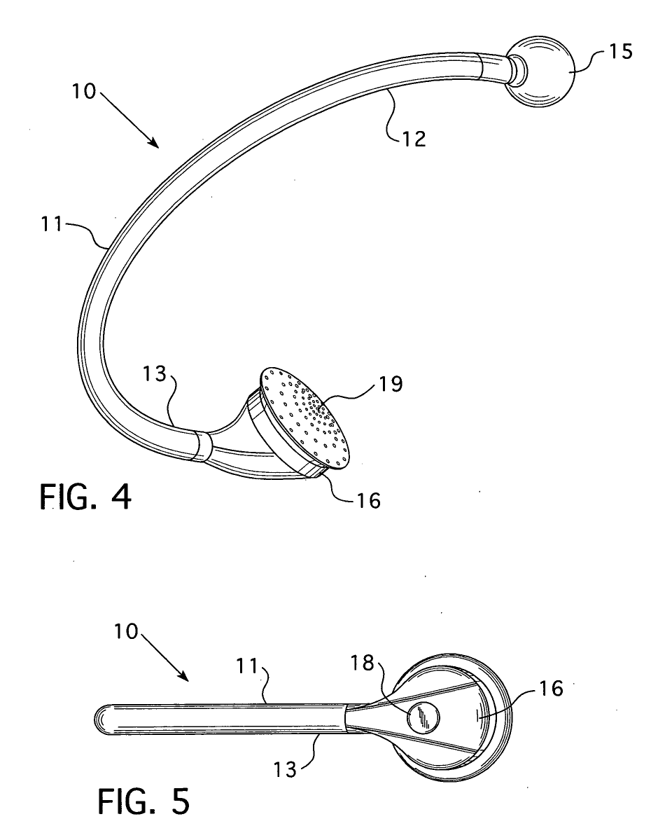

The embodiment shown in FIGS. 4 and 5 is identical to that illustrated in FIG. 2, except for the fact that terrycloth cover 21 is eliminated and the hollow tubular handle 11 is not segmented, but instead is one continuous tubular piece of substantially rigid plastic tubing.

The porous applicator 19 maybe of any suitable material, such as a pad of porous polyurethane sponge.

1. A liquid soap or lotion applicator for hard-to-reach areas of the body, comprising:
a substantially rigid elongated tubular handle with opposite ends and hollow tubular interior;
a low pressure squeeze bulb secured to one end of said tubular handle for forcing air under low pressure through said elongated tubular handle;
a hollow head connected to the opposite end of said elongated tubular handle with a reservoir therein communicating with the hollow tubular interior of said handle and having a removable access for pouring liquid soap or lotion therein;
a porous applicator removably securable to said head with an interior face thereof exposed to said reservoir whereby liquid in said reservoir will be forced through said porous applicator for application to the body; and
said handle having a fixed arcuate shape which extends through a curvature of approximately 180° and said porous applicator has an exterior face which faces toward the bulb end of said tubular handle.

2. The applicator of claim 1, wherein said removable porous applicator includes external bristles for soap application.

3. (canceled)

4. The applicator of claim 1, wherein said tubular handle is reattachably divisible intermediate its opposite ends for convenient storage.
